(19) United States
(12) Patent Application Publication
(10) Pub. No.: US 2026/0147135 A1
(43) Pub. Date: May 28, 2026

(54) GRAVITY FIELD INTERPOLATION METHOD AND DEVICE, AND STORAGE MEDIUM

(71) Applicant: Beihang University, Beijing (CN)

(72) Inventors: Zhen Li, Beijing (CN); Chuang Shi, Beijing (CN); Yuxue Yin, Tianjin (CN)

(21) Appl. No.: 19/398,146

(22) Filed: Nov. 24, 2025

(30) Foreign Application Priority Data
Nov. 26, 2024 (CN) 2024116972416

(51) Int. Cl. G01V 7/16; G01P 15/18

(52) U.S. Cl. CPC G01V 7/16; G01P 15/18

(57) ABSTRACT

A gravity field interpolation method and device, and a storage medium are provided. The method includes: generating, by a server, sampling points in a grid corresponding to a satellite orbit; obtaining, by the server, coefficients of a polynomial based on measured values of the sampling points; and converting, by a client, an ECI coordinate at a reference time into a RTN coordinate corresponding to a grid cell, and normalizing the RTN coordinate to obtain a normalized RTN coordinate; and substituting the normalized RTN coordinate into the polynomial, calculating a gravitational acceleration before a J₂ term of a spherical harmonic gravity field by using a spherical harmonic method, and calculating a gravitational acceleration after the J₂ term of the spherical harmonic gravity field by using a polynomial interpolation method. The method can improve a calculation efficiency of a real-time orbit determination algorithm, and reduce a computational load of on-orbit data processing.

### CROSS-REFERENCE TO RELATED APPLICATION

This application claims priority to Chinese Patent Application No. 202411697241.6, filed on Nov. 26, 2024, which is herein incorporated by reference in its entirety.

### TECHNICAL FIELD

The disclosure relates to the technical field of satellite dynamics, and more particularly to a gravity field interpolation method and device, and a storage medium suitable for satellite-borne global navigation satellite system (GNSS) autonomous orbit determination.

### BACKGROUND

With development of aerospace technology, aerospace missions such as high-resolution remote sensing satellite earth observation and real-time geocoding, and formation flying of scientific exploration satellites have imposed higher requirements on the accuracy, real-time performance, and autonomy of satellite orbit determination.

In satellite-borne global positioning system (GPS) real-time orbit determination algorithms, satellite-borne GPS pseudo-range observations are typically used in combination with simplified dynamic models, and in-orbit data processing is performed by using an extended Kalman filter to obtain high-precision satellite orbit parameters. In the extended filter processing, dynamic orbit integration and prediction generally use a single-step integration method in a Runge-Kutta family, and each integration requires multiple calculations of a gravitational acceleration of Earth. In order to improve a real-time orbit determination accuracy of low-orbit satellites, an Earth gravity field model needs to be precise up to degree and order 50×50 or even 70×70. The higher the model order, the greater the computational load for calculating the gravitational acceleration of Earth by using a traditional spherical harmonic recursion algorithm.

Currently, a computational capability of an internal processor of a satellite-borne GPS receiver and a satellite-borne processor is far lower than that of a ground-based personal computer (PC) processor. In order to enable a high-precision satellite-borne GPS real-time orbit determination algorithm to enter engineering applications, there is an urgent need to improve a computational efficiency of a real-time orbit determination algorithm, particularly by optimizing a dynamic orbit integration algorithm to reduce a computational load of on-orbit data processing.

### SUMMARY

A technical problem to be solved in the disclosure is to provide a gravity field interpolation method and device, and a storage medium suitable for satellite-borne GNSS autonomous orbit determination, to improve a calculation efficiency of a real-time orbit determination algorithm, and reduce a computational load of on-orbit data processing.

In order to achieve the above purpose, the disclosure adopts the following technical solution.

A gravity field interpolation method includes:
step S1, generating, by a server, sampling points in a grid corresponding to a satellite orbit;
step S2, obtaining, by the server, coefficients of a polynomial based on measured values of the sampling points; and
step S3, converting, by a client, an Earth-centered inertial (ECI) coordinate at a reference time into a radial-transverse-normal (RTN) coordinate corresponding to a grid cell, and normalizing the RTN coordinate to obtain a normalized RTN coordinate; and substituting the normalized RTN coordinate into the polynomial, calculating a gravitational acceleration before a J₂ term of a spherical harmonic gravity field by using a spherical harmonic method, and calculating a gravitational acceleration after the J₂ term of the spherical harmonic gravity field by using a polynomial interpolation method.

In an embodiment, the gravity field interpolation method further includes:
step S4, synthesizing the gravitational acceleration before the J₂ term and the gravitational acceleration after the J₂ term to form a total gravitational acceleration; and inputting the total gravitational acceleration into a dynamic model of a satellite-borne extended Kalman filter to update a satellite orbit state vector in real time, thereby achieving satellite-borne GNSS autonomous orbit determination.

In an embodiment, the step S1 includes:
step S11, determining the grid corresponding to the satellite orbit; and
step S12, designing the sampling points in the grid according to a Chebyshev node distribution.

In an embodiment, the step S2 includes:
step S21, generating a candidate polynomial;
step S22, obtaining a selected polynomial based on the candidate polynomial;
step S23, obtaining the coefficients of the polynomial based on the measured values of the sampling points and the selected polynomial; and
step S24, verifying whether an internal conformity accuracy for the sampling points meets a standard; in response to the internal conformity accuracy meeting the standard, storing the coefficients of the polynomial, in response to the internal conformity accuracy not meeting the standard, increasing an order of the polynomial and repeating the step S21 through the step S23.

The disclosure further provides a gravity field interpolation device, including a first processing module, a second processing module and a third processing module.

The first processing module is configured to generate, by a server, sampling points in a grid corresponding to a satellite orbit.

The second processing module is configured to obtain, by the server, coefficients of a polynomial based on measured values of the sampling points.

The third processing module is configured to convert, by a client, an ECI coordinate at a reference time into a RTN coordinate corresponding to a grid cell, and normalize the RTN coordinate to obtain a normalized RTN coordinate; and substitute the normalized RTN coordinate into the polynomial, calculate a gravitational acceleration before a J₂ term of a spherical harmonic gravity field by using a spherical harmonic method, and calculate a gravitational acceleration after the J₂ term of the spherical harmonic gravity field by using a polynomial interpolation method.

In an embodiment, the first processing module includes a determination unit and a design unit.

The determination unit is configured to determine the grid corresponding to the satellite orbit.

The design unit is configured to designing the sampling points in the grid according to a Chebyshev node distribution.

In an embodiment, the second processing module includes a generation unit, a selecting unit, a calculation unit and a verifying unit.

The generation unit is configured to generate a candidate polynomial.

The selecting unit is configured to obtain a selected polynomial based on the candidate polynomial.

The calculation unit is configured to obtain the coefficients of the polynomial based on the measured values of the sampling points and the selected polynomial.

The verifying unit is configured to verify whether an internal conformity accuracy for the sampling points meets a standard; and in response to the internal conformity accuracy meeting the standard, store the coefficients of the polynomial.

In an exemplary embodiment, each of the first processing module, the second processing module, the third processing module, the determination unit, the design unit, the generation unit, the selecting unit, the calculation unit and the verifying unit is embodied by at least one processor and at least one memory coupled to the at least one processor, and the at least one memory stores computer programs executable by the at least one processor.

The disclosure further provides a non-transitory storage medium, having a computer program stored therein. The computer program is configured to implement the gravity field interpolation method when the computer program is executed.

The disclosure introduces a gravity field interpolation algorithm and applies it to gravity field calculations for satellite-borne GPS autonomous orbit determination. In order to save a time required for spherical harmonic recursion operations, it proposes dividing the space into multiple regions. For each small “cell”, a polynomial is pre-selected to fit high-order terms of the gravitational acceleration in that region, and the coefficients of the polynomial are stored in advance. The client only needs to perform coordinate conversion and invoke the polynomial to calculate the satellite gravitational acceleration at that location. In computing the local gravity field, the disclosure trades storage space for computational time. While improving the computational efficiency of the gravity field, the adaptive polynomial algorithm of the disclosure also ensures the computational accuracy of the gravity field.

### BRIEF DESCRIPTION OF DRAWINGS

In order to provide a clearer explanation of technical solutions in embodiments of the disclosure or related art, drawings required in embodiments or the related art descriptions will be briefly introduced below. Apparently, the drawings in the following descriptions are merely some of the embodiments of the disclosure. For those skilled in the art, other drawings can be obtained according to these drawings without creative work.

FIG. 1 illustrates a flowchart of a gravity field interpolation method according to an embodiment of the disclosure.

FIG. 2 illustrates a schematic diagram of grid spatial distribution according to an embodiment of the disclosure.

### DETAILED DESCRIPTION OF EMBODIMENTS

The technical solutions in embodiments of the disclosure will be clearly and completely described in conjunction with the accompanying drawings below. Apparently, the described embodiments are merely some of the embodiments of the disclosure, not all of the embodiments. Based on the embodiments of the disclosure, all other embodiments obtained by those skilled in the art without creative labor are within a scope of protection of the disclosure.

In order to make the above objectives, features, and advantages of the disclosure more obvious and understandable, the following will provide further detailed explanations of the disclosure in conjunction with the accompanying drawings and specific embodiments.

### Embodiment 1

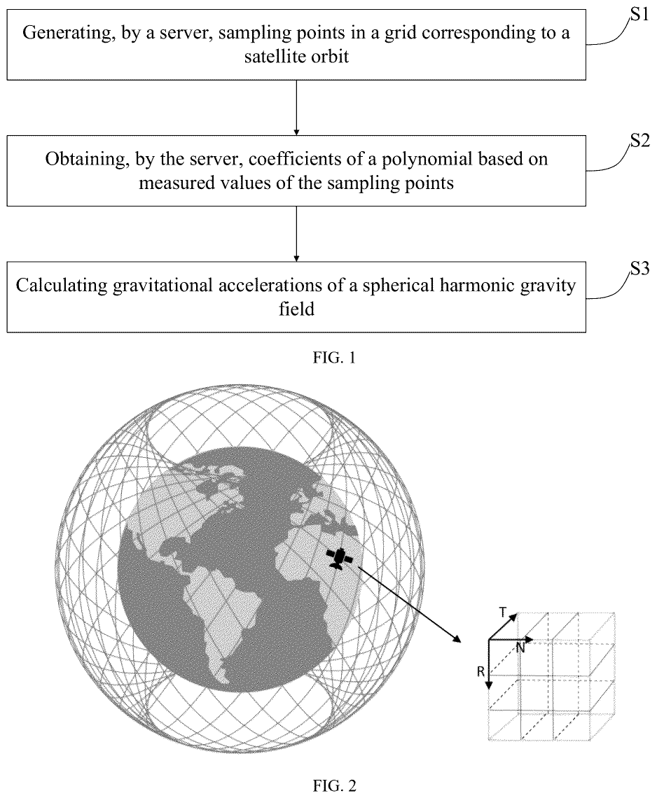

As shown in FIG. 1, the embodiment of the disclosure provides a gravity field interpolation method for satellite-borne GNSS autonomous orbit determination, and the gravity field interpolation method includes the following steps S1-S3.

In step S1, a server generates sampling points in a grid corresponding to a satellite orbit.

In step S2, the server obtains coefficients of a polynomial based on measured values of the sampling points.

In step 3, a client converts an ECI coordinate at a reference time into a RTN coordinate corresponding to a grid cell, and normalizes the RTN coordinate to obtain a normalized RTN coordinate; and substitutes the normalized RTN coordinate into the polynomial, calculates a gravitational acceleration before a J₂ term of a spherical harmonic gravity field by using a spherical harmonic method, and calculates a gravitational acceleration after the J₂ term of the spherical harmonic gravity field by using a polynomial interpolation method.

In an embodiment, the step S1 includes the following steps S11-S12.

In step S11, the grid corresponding to the satellite orbit is determined.

Starting from a perigee of the satellite, a point is taken every 1 degree for true anomaly, to obtain 360 points along an orbit. These points are rotated around a z-axis, and coordinates after each 1-degree rotation are recorded, finally obtaining 360×360 cells. A geometric shape of each cell is a rectangular cuboid, whose three edge directions are parallel to the three axes of the RTN coordinate system at a current position of the satellite, as shown in FIG. 2. The grid size must ensure the absence of singular regions. Lengths in the T and N directions should be as small as possible while guaranteeing no singular regions, and a length in the R direction can also be set to a relatively small value, primarily since the R direction remains relatively stable when the satellite is in different grid cells.

In step S12, the sampling points in the grid are designed.

The sampling points in the grid are designed according to a Chebyshev node distribution. A sampling equation is expressed as follows:

$${x}_{i} = cos ( \frac{2 i - 1}{2 m} π ) , i = 1 … m ;$$

where m³ represents a total number of the sampling points, and m points are taken in each dimension; the dimensions are independent of each other, this selection of locations helps to minimize the Runge phenomenon and enhances the stability of the fit.

In an embodiment of the disclosure, the step S2 includes the following steps S21-S24.

In step S21, a candidate polynomial is generated.

The candidate polynomial is a polynomial potentially used for interpolating and fitting the gravity field. The candidate polynomial is expressed as follows:

$${Q}_{d} = {\sum }_{a = 0}^{d} {\sum }_{b = 0}^{a} {\sum }_{c = 0}^{a - b} {C}_{σ} {y}_{1}^{a - b - c} {y}_{2}^{c} {y}_{3}^{b} ;$$

where y₁, y₂ and y₃ represent three components of a normalized coordinate of a point to be calculated respectively, C represents a polynomial coefficient, C_{σ} represents an element in C, σ represents a total cumulative loop counter, d represents a total degree of the polynomial, and a, b and c represent variables in a summation process.

In step S22, a selected polynomial is obtained based on the candidate polynomial.

Since the gravitational acceleration changes slowly in a radial direction, a lower degree is sufficient to fit the variation of acceleration in the radial direction. Therefore, the selected polynomial can omit some high-degree terms in the radial direction to reduce the storage burden.

d=2 is taken as an example:

$${Q}_{2} = {C}_{1} + {C}_{2} {y}_{1} + {C}_{3} {y}_{2} + {C}_{4} {y}_{3} + {C}_{5} {y}_{1}^{2} + {C}_{6} {y}_{1} {y}_{2} + {C}_{7} {y}_{2}^{2} + {C}_{8} {y}_{1} {y}_{3} + {C}_{9} {y}_{2} {y}_{3} + {C}_{10} {y}_{3}^{2} .$$

When selecting the candidate polynomial, it is possible to consider polynomials that remove the C₈, C₉ and C₁₀ terms, and a lower-degree can be select for fit for y₃, which corresponds to the radial direction.

In step S23, the coefficients of the polynomial are obtained based on the measured values of the sampling points and the selected polynomial.

Each sampling point corresponds to a measured value uᵢ, i=1 . . . m³, and the coefficients C of the polynomial are solved as follows:

$$YC = u ;$$

where Y represents a matrix formed from the Chebyshev sampling points; u represents a column vector, and each element of which corresponds to the measured value of a sampling point.

Since there are m sampling positions in each dimension, there are a total of m³ sampling points used to solve for the coefficients of the polynomial. Furthermore, since the order is N, the matrix Y is a matrix with m³ rows and N columns. The polynomial coefficient C to be solved is an N-row column vector. A solution for C is solved by using a least squares formula as follows:

$$C = {( {Y}^{T} Y )}^{- 1} {Y}^{T} u ;$$

where Y^{T} represents a transpose of the matrix Y.

In step S24, gravitational accelerations of the fitted polynomial at the sampling points are calculated, and the gravitational accelerations are compared with the results calculated by the spherical harmonic method to obtain modeling residuals and root mean square (RMS) of the modeling residuals at the sampling points, thereby verifying whether an internal conformity accuracy for the sampling points meets a standard. In response to the internal conformity accuracy meeting the standard, the candidate polynomial can be retained as the polynomial for interpolation fitting. In response to the internal conformity accuracy not meeting the standard, the candidate polynomial is changed, and the above steps S21 to S23 are repeated.

In an embodiment of the disclosure, the step S3 includes the following steps S31-S34.

In step S31, a current time t and the reference time t₀ are updated. A rotation matrix Rₜ from an inertial system to an earth-centered earth-fixed (ECEF) system at the current time t and a rotation matrix Rₜ_{₀} from the inertial system to the ECEF system at the reference time t₀ are calculated.

In step S32, the ECI coordinate is converted to the ECEF system by using the rotation matrix Rₜ to obtain a converted coordinate, and the converted coordinate is converted to an ECI coordinate at the reference time t₀ by using an inverse matrix of the rotation matrix Rₜ_{₀}. At this time, a true anomaly, and a right ascension of an ascending node are calculated by using a state vector that has undergone coordinate transformation to the reference time, thereby locating a corresponding grid cell position in the reference coordinate system.

In step S33, the ECI coordinate at the reference time t₀ is converted to a RTN coordinate corresponding to the grid cell, and the RTN coordinate is normalized.

In step S34, the normalized RTN coordinate is substituted into the polynomial, the gravitational acceleration before the J₂ term of the spherical harmonic gravity field is calculated by using the spherical harmonic method, and the gravitational acceleration after the J₂ term of the spherical harmonic gravity field is calculated by using the polynomial interpolation method.

In an embodiment, the spherical harmonic gravity field U is expressed as follows:

$$U = {U}_{{J}_{1}} + {U}_{{J}_{2}} + {U}_{F} ;$$

where U_{J}_{₁} and U_{J}_{₂} each represent the gravitational acceleration before the J₂ term of the spherical harmonic gravity field, and U_{F} represents the gravitational acceleration after the J₂ term of the spherical harmonic gravity field.

Analytical solutions for U_{J}_{₁} and U_{J}_{₂} are as follows:

$${U}_{{J}_{1}} = - \frac{μ}{r} ;$$

$${U}_{{J}_{2}} = - \frac{μ}{r} [ {{J}_{2} ( \frac{{R}_{e}}{r} )}^{2} {P}_{2} ( sin ( φ ) ] ;$$

where μ represents a reference gravitational constant, Rₑ represents an Earth radius, r represents a magnitude of a position vector, φ represents a geocentric latitude, and P₂ represents a second-order Legendre polynomial.

In an embodiment, U_{F} is obtained by using polynomial fitting.

The embodiment of the disclosure uses the grid interpolation method to calculate the gravitational acceleration of the satellite, which significantly reduces the time complexity and lessens the demand on the computational power of the satellite for real-time orbit determination. The embodiment of the disclosure employs an adaptive polynomial, which ensures the polynomial meeting accuracy requirements while reducing the number of coefficients needed, thereby decreasing storage usage compared to other grid interpolation algorithms.

### Embodiment 2

The disclosure further provides a gravity field interpolation device, including a first processing module, a second processing module and a third processing module.

The first processing module is configured to generate, by a server, sampling points in a grid corresponding to a satellite orbit.

The second processing module is configured to obtain, by the server, coefficients of a polynomial based on measured values of the sampling points.

The third processing module is configured to convert, by a client, an ECI coordinate at a reference time into a RTN coordinate corresponding to a grid cell, and normalize the RTN coordinate to obtain a normalized RTN coordinate; and substitute the normalized RTN coordinate into the polynomial, calculate a gravitational acceleration before a J₂ term of a spherical harmonic gravity field by using a spherical harmonic method, and calculate a gravitational acceleration after the J₂ term of the spherical harmonic gravity field by using a polynomial interpolation method.

In an embodiment, the first processing module includes a determination unit and design unit.

The determination unit is configured to determine the grid corresponding to the satellite orbit.

The design unit is configured to designing the sampling points in the grid according to a Chebyshev node distribution.

In an embodiment, the second processing module includes a generation unit, a selecting unit, a calculation unit and a verifying unit.

The generation unit is configured to generate a candidate polynomial.

The selecting unit is configured to obtain a selected polynomial based on the candidate polynomial.

The calculation unit is configured to obtain the coefficients of the polynomial based on the measured values of the sampling points and the selected polynomial.

The verifying unit is configured to verify whether an internal conformity accuracy for the sampling points meets a standard; and in response to the internal conformity accuracy meeting the standard, store the coefficients of the polynomial.

The disclosure further provides a non-transitory storage medium, having a computer program stored therein. The computer program is configured to implement the gravity field interpolation method when the computer program is executed.

The above embodiments are only a description of some of the embodiments of the disclosure and do not limit the scope of the disclosure. Without departing from a design spirit of the disclosure, various modifications and improvements made by those skilled in the art to the technical solution of the disclosure should fall within the scope of protection determined by the claims of the disclosure.

What is claimed is:

1. A gravity field interpolation method, comprising:
step S1, generating, by a server, sampling points in a grid corresponding to a satellite orbit;
step S2, obtaining, by the server, coefficients of a polynomial based on measured values of the sampling points; and
step S3, converting, by a client, an Earth-centered inertial (ECI) coordinate at a reference time into a radial-transverse-normal (RTN) coordinate corresponding to a grid cell, and normalizing the RTN coordinate to obtain a normalized RTN coordinate; and substituting the normalized RTN coordinate into the polynomial, calculating a gravitational acceleration before a J₂ term of a spherical harmonic gravity field by using a spherical harmonic method, and calculating a gravitational acceleration after the J₂ term of the spherical harmonic gravity field by using a polynomial interpolation method;
wherein the step S1 comprises:
step S11, determining the grid corresponding to the satellite orbit; and
step S12, designing the sampling points xᵢ in the grid according to a Chebyshev node distribution; wherein a sampling equation is expressed as follows:
$${x}_{i} = cos ( \frac{2 i - 1}{2 m} π ) , i = 1 … m ;$$
wherein m³ represents a total number of the sampling points, and m points are taken in each dimension;
wherein the step S2 comprises:
step S21, generating a candidate polynomial as follows:
$${Q}_{d} = {\sum }_{a = 0}^{d} {\sum }_{b = 0}^{a} {\sum }_{c = 0}^{a - b} {C}_{σ} {y}_{1}^{a - b - c} {y}_{2}^{c} {y}_{3}^{b} ;$$
wherein y₁, y₂ and y₃ represent three components of a normalized coordinate of a point to be calculated respectively, C represents a polynomial coefficient, C_{σ} represents an element in C, σ represents a total cumulative loop counter, d represents a total degree of the polynomial, and a, b and c represent variables in a summation process;
step S22, obtaining a selected polynomial based on the candidate polynomial;
step S23, obtaining the coefficients of the polynomial based on the measured values of the sampling points and the selected polynomial; and
step S24, verifying whether an internal conformity accuracy for the sampling points meets a standard; in response to the internal conformity accuracy meeting the standard, storing the coefficients of the polynomial, in response to the internal conformity accuracy not meeting the standard, increasing an order of the polynomial and repeating the step S21 through the step S23;
wherein in the step S3, the spherical harmonic gravity field U is expressed as follows:
$$U = {U}_{{J}_{1}} + {U}_{{J}_{2}} + {U}_{F} ;$$
wherein U_{J}_{₁} and U_{J}_{₂} each represent the gravitational acceleration before the J₂ term of the spherical harmonic gravity field, and Up represents the gravitational acceleration after the J₂ term of the spherical harmonic gravity field;
wherein analytical solutions for U_{J}_{₁} and U_{J}_{₂} are as follows:
$${U}_{{J}_{1}} = - \frac{μ}{r} ;$$
$${U}_{{J}_{2}} = - \frac{μ}{r} [ {{J}_{2} ( \frac{{R}_{e}}{r} )}^{2} {P}_{2} ( sin ( φ ) ] ;$$
wherein μ represents a reference gravitational constant, Rₑ represents an Earth radius, r represents a magnitude of a position vector, φ represents a geocentric latitude, and P₂ represents a second-order Legendre polynomial; and
wherein U_{F} is obtained by using polynomial fitting.

2. A gravity field interpolation device for implementing the gravity field interpolation method as claimed in claim 1, comprising:
a first processing module, configured to generate, by the server, the sampling points in the grid corresponding to the satellite orbit;
a second processing module, configured to obtain, by the server, the coefficients of the polynomial based on the measured values of the sampling points; and
a third processing module, configured to convert, by the client, the ECI coordinate at the reference time into the RTN coordinate corresponding to the grid cell, and normalize the RTN coordinate to obtain the normalized RTN coordinate; and substitute the normalized RTN coordinate into the polynomial, calculate the gravitational acceleration before the J₂ term of the spherical harmonic gravity field by using the spherical harmonic method, and calculate the gravitational acceleration after the J₂ term of the spherical harmonic gravity field by using the polynomial interpolation method.

3. A storage medium, having a computer program stored therein, wherein the computer program is configured to implement the gravity field interpolation method as claimed in claim 1 when the computer program is executed.
